(19) United States
(12) Patent Application Publication
(10) Pub. No.: US 2006/0031262 A1
(43) Pub. Date: Feb. 9, 2006

(54) Synchronizing client data and server data

(75) Inventors: Satoru Satoh, Yamato-shi (JP); Tohru Tachibana, Yokohama-shi (JP)

Correspondence Address: IBM CORPORATION, 3039 CORNWALLIS RD., DEPT. T81 / B503, PO BOX 12195, REASEARCH TRIANGLE PARK, NC, 27709, US

(73) Assignee: International Business Machines Corporation, Armonk, NY (US)

(21) Appl. No.: 11/006,916

(22) Filed: Dec. 8, 2004

(30) Foreign Application Priority Data
Dec. 12, 2003 (JP) 2003-414203

(51) Int. Cl. G06F 17/30

(52) U.S. Cl. 707/200

(57) ABSTRACT

To synchronize client data and server data, while reducing the number of transactions, a server has a sending-confirmed information storage section which stores, as a sending-confirmed list, content last confirmed in a client; an update data set storage section which stores the updated data set to be held by the client; an update information sending section which sends the difference between a data set identified from the sending-confirmed list and an updated data set; a sent information updating section which stores in a sent information storage section content of the updated data set as a sent list; an update request receiving section which receives an update request from the client; and a sending-confirmed information updating section which replaces the sending-confirmed list with the sent list if the content of the data set held by the client is different from the content of the data set identified from the sending-confirmed list.

### FIELD OF THE INVENTION

The present invention relates to synchronizing data held by a client with data held by a server, responsive to an update request from the client.

### BACKGROUND

When data is shared between a server and a client, there is a need to consider synchronization. Push-type synchronization may be used, in which a portable terminal which is a client holds the newest data, a server obtains the newest data, and the client notifies the server when data held by the client is updated.

On the other hand, a system is conceivable in which the sever holds the newest data and the client obtains and uses the newest data from the server. For example, both the client and the server in the system hold a form which is used for online shopping, in which a purchaser, a desired product, a payment method, and so forth, are entered. If the form held by the server is changed, the client obtains the newly changed form from the server.

In this system, if a portable information terminal such as a portable telephone is used as the client, there is a possibility that the client may not be ready when the server notifies the client of a data update. To avoid this situation, the server may periodically poll its clients. However, this results in increased communication traffic. Consequently, a pull-type synchronization method is ordinarily used, in which the client requests the server to update data held by the client, and the server sends update information if there is an update available.

When HTTP is used, however, push updates from servers cannot be performed. Thus, in such a case, a pull-type synchronization method is normally used.

Conventionally, a pull-type synchronization method such as shown in FIG. 10 may be used. That is, a server 90 holds a sending-confirmed list, which identifies a data set sent to the client 80 and receipt-confirmed by the client 80, determines the difference between the data set after updating and the sending-confirmed data set according to the update request from the client 80, and sends information on the difference to the client 80. When the server 90 receives an acknowledgement or “Ack” from the client 80, the sever 90 determines that update of the data set in the client 80 has been completed, and updates the sending-confirmed list.

In the conventional method shown in FIG. 10, however, requires at least two transactions: (1) sending an update request from the client and update contents from the server, and (2) communicating the various acknowledgements. As a result, the number of transactions is disadvantageously large, and the overhead per transaction is increased, particularly when the client is a portable information terminal such as a portable telephone.

### SUMMARY

The present invention provides an arrangement in which the completion of an update of a data set in a client is confirmed at the time of the next update request. That is, a data set updating apparatus of the present invention has an update information sending section which sends update information for updating a data set held by a recipient computer such as a terminal or client to the recipient computer, a sent information management section (corresponding to a sent information storage section and a sent information updating section) which manages the update information sent by the update information sending section, an update request receiving section which receives an update request from the recipient computer, the update request including update condition information indicating the condition of update of the data set held by the recipient computer, and a sending-confirmed information management section (corresponding to the sending-confirmed information storage section and a sending-confirmed information updating section) which manages, as sending-confirmed information indicating the update of the data set according to the update information, the update information stored as the sent information if it is determined that the recipient computer is holding the data set updated according to the update information, on the basis of the update condition information received by the update request receiving section.

According to another aspect of the present invention, a data set updating apparatus has a management information storage section (corresponding to a sent information storage section and a sending-confirmed information storage section) which stores, for a data set sent to a recipient computer, sending-confirmed data set management information identifying content confirmed most recently in the recipient computer (sending-confirmed list) and sent data set management information identifying content updated according to update information sent most recently (sent list), an update request receiving section which receives an update request including update condition information indicating the condition of update of the data set held by the recipient computer, and a management information updating section (corresponding to a sent information updating section and a sending-confirmed information updating section) which performs update processing for replacing the sending-confirmed data set management information in the management information storage section with the sent data set management information if it is determined that the content of the data set held by the recipient computer is different from the content of the data set identified from the sending-confirmed data set management information, on the basis of the update condition information received by the update request receiving section.

According to the present invention, the state of the data set in the client is managed by using two-valued tokens. The server can deduce the state of the data currently held on the client based on the values of two-valued tokens exchanged between the server and the client. Since the list is not sent by the client, the amount of communicated data can be reduced. Because the client is managed using the two-valued tokens, the present invention also has the advantage of simplifying the management mechanism.

The present invention also encompasses a terminal device that confirms the completion of update of a data set at the time of its next update request. The terminal device of the present invention in this case has a data set storage section which stores a data set, an updated processing section which receives update information and updates the data set stored in the data set storage section according to the update information, and an update request sending section which sends information indicating that update of the data set has been completed, the information being included in a request for further updating the updated data set.

Another aspect of the present invention includes a data set updating method in which a first computer updates a data set held by a second computer. This method includes a step of storing, for a data set sent to the second computer, sending-confirmed data set management information identifying content confirmed most recently in the second computer and sent data set management information identifying content updated according to update information sent most recently, a step of receiving an update request including update condition information indicating the condition of update of the data set held by the second computer, and a step of performing update processing for replacing the sending-confirmed data set management information with the sent data set management information if it is determined that the content of the data set held by the second computer is different from the content of the data set identified from the sending-confirmed data set management information on the basis of the received update condition information.

Another aspect of the present invention includes a computer program installed in a server to update a data set held by a terminal device. The program of the present invention in this case is a program for operating, on a-data set sent to a terminal device, a server computer storing sending-confirmed data set management information identifying content confirmed most recently in the terminal device, and sent data set management information identifying content updated according to update information sent most recently. The program enables the server computer to perform the function of receiving an update request including update condition information indicating the condition of update of the data set held by the terminal device, and to perform update processing for replacing the sending-confirmed data set management information with the sent data set management information if it is determined that the content of the data set held by the terminal device is different from the content of the data set identified from the sending-confirmed data set management information on the basis of the received update condition information.

Another aspect of the present invention includes a computer program installed in a terminal device that confirms the completion of an update of a data set at the time of its next update request. The program of the present invention in this case enables a computer to perform the function of receiving update information and performing update of a data set according to the update information, and the function of transmitting information indicating the completion of an update of the data set by including the information in a request for further updating the updated data set.

### BRIEF DESCRIPTION OF THE DRAWINGS

FIG. 1 is a block diagram showing an exemplary configuration of a client-server system according to an embodiment of the present invention.

FIG. 2 is a flowchart showing the operation of a client.

FIG. 3 is a flowchart showing the operation of a server.

FIG. 4 shows exemplary details according to the invention.

FIG. 5 shows further exemplary details according to the invention.

FIG. 6 shows further exemplary details according to the invention.

FIG. 7 shows further exemplary details according to the invention

FIG. 8 shows further exemplary details according to the invention.

FIG. 9 is a diagram in which patterns of operation according to the invention are shown.

FIG. 10 is a diagram showing a configuration of a client-server system according to the prior art.

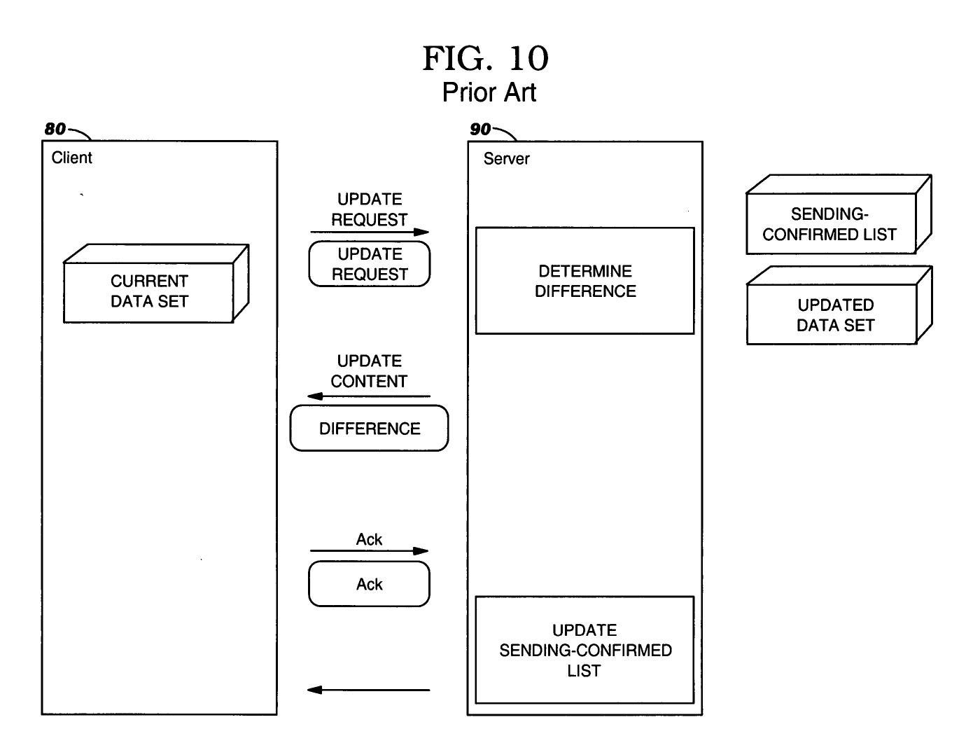

### DETAILED DESCRIPTION

An illustrative embodiment of the present invention will now be described in detail with reference to the accompanying drawings.

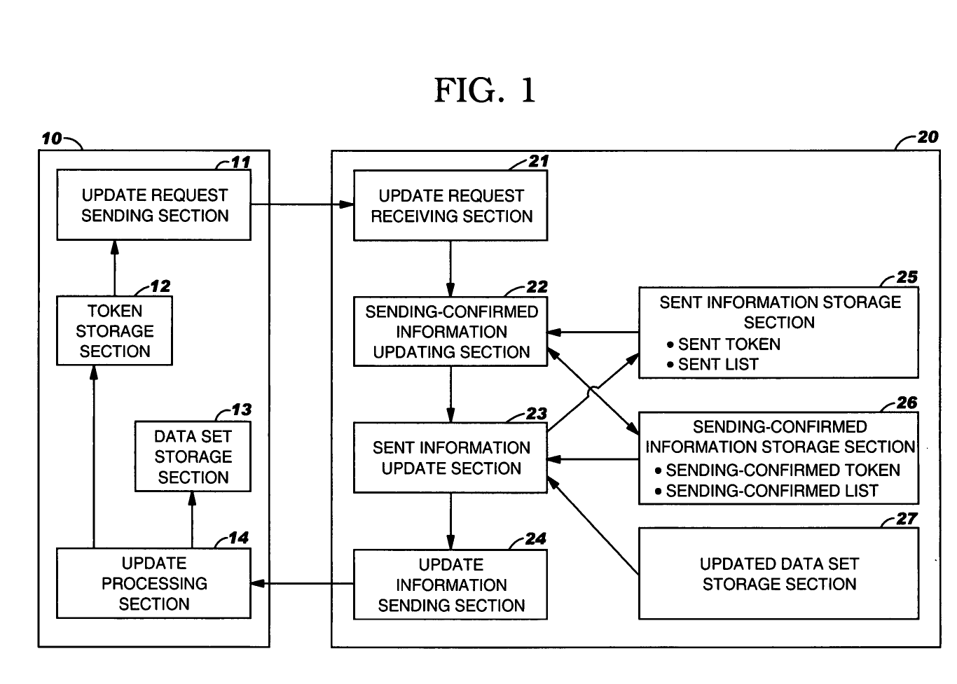

FIG. 1 is a diagram showing an exemplary configuration of a client-server system in this embodiment. As shown in FIG. 1, the client-server system includes a client 10 and a server 20. The client 10 includes an update request sending section 11, a token storage section 12, a data set storage section 13, and an update processing section 14. The server 20 includes an update request receiving section 21, a sending-confirmed information updating section 22, a sent information updating section 23, an update information sending section 24, a sent information storage section 25, a sending-confirmed information storage section 26, and an updated data set storage section 27.

The data set storage section 13 includes means for storing a data set used in the client 10. The token storage section 12 includes means for storing a token, which token has two-value information indicating the condition of update of the data set stored in the data set storage section 13. The update request sending section 11 includes means for sending the token stored in the token storage section 12 as an update request to the server 20. The update processing section 14 includes means for updating the data set stored in the data set storage section 13 according to update information sent from the server 20.

The sent information storage section 25 includes means such as a slot for storing a sent list and a sent token. The sent list is a list for identifying, with respect to a data set sent to the client 10, contents after update according to update information last sent. Information recorded in the sent list may include, for example, names of components constituting the data set and a time stamp. However, any other information may be used as well if the information enables identification of the components and versions. The sent token includes two-valued information indicating the condition of update of the sent list.

The sending-confirmed information storage section 26 includes means such as a slot for storing a sending-confirmed list and a sending-confirmed token. The sending-confirmed list is a list for identifying, with respect to a data set sent to the client 10, contents at the point in time when the completion of sending to the client 10 is finally confirmed. Information recorded in the sending-confirmed list may include, for example, names of components constituting the data set and a time stamp. However, any other information may be used as well if the information enables identification of the components and versions. The sending-confirmed token includes two-valued information indicating the condition of update of the sending-confirmed list.

The updated data set storage section 27 includes means for storing a data set in the data set storage section 13 of the client 10 after updating of the data set.

The update request receiving section 21 includes means for receiving the token sent as an update request from the client 10. The sending-confirmed information updating section 22 includes means for updating the sending-confirmed token and the sending-confirmed list stored in the sending-confirmed information storage section 26 responsive to a comparison among the token received by the update request receiving section 21, the sent token stored in the sent information storage section 25, and the sending-confirmed token stored in the sending-confirmed information storage section 26. The sent information updating section 23 includes means for updating the sent token and the sent list stored in the sent information storage section 25 responsive to a comparison between the data set identified from the sending-confirmed list stored in the sending-confirmed information storage section 26 and the data set stored in the updated data set storage section 27, and generating the token and update information to be sent to the client 10. The update request sending section 24 includes a means for sending the token and update information generated by the sent information updating section 23 to the client 10.

An ordinary computer architecture may be used to provide the client 10 and the server 20. That is, a configuration suffices which includes a central processing unit (CPU) and a main memory, and in which the central processing unit and the main memory are connected to an auxiliary storage via a bus. The auxiliary storage may be, for example, a hard disk, a flexible disk, an MO (magneto-optical disk), a CD-ROM, or the like.

A computer program for realizing the functions of the update request sending section 11 and the update processing section 14 may be stored in the auxiliary storage of the client 10. That is, the central processing unit (CPU) of the client 10 (not shown in the figure) reads this computer program to the main memory and executes the computer program to realize the functions of the update request sending section 11 and the update processing section 14. The auxiliary storage may also be used as the token storage section 12 and the data set storage section 13. The computer program and data stored in the auxiliary storage may be read directly from a recording medium (not shown in the figure), or may be provided via a computer network.

A computer program for realizing the functions of the update request receiving section 21, the sending-confirmed information updating section 22, the sent information updating section 23, and the update information sending section 24 may be stored in the auxiliary storage of the server 20. That is, the central processing unit (CPU) of the server 20 (not shown in the figure) reads this computer program to the main memory and executes the computer program to realize the functions of the update request receiving section 21, the sending-confirmed information updating section 22, the sent information updating section 23, and the update information sending section 24. The auxiliary storage may also be used as the sent information storage section 25, the sending-confirmed information storage section 26, and the updated data set storage section 27. The computer program and data stored in the auxiliary storage may be read directly from a recording medium (not shown in the figure), or may be provided via a computer network.

The operation of this embodiment will now be described in detail. In this description, a token held by the client 10 is denoted by “token tc”; a sent token held by the server 20 is “token ts1”; a sending-confirmed token held by the server is “token ts2”; a data set held by the client 10 is “data set Sc”; a data set identified from the sent list held by the server 20 is “data set S1”; a data set identified from the sending-confirmed list held by the server 20 is “data set S2”; and an updated data set held by the server 20 is “data set Sn”.

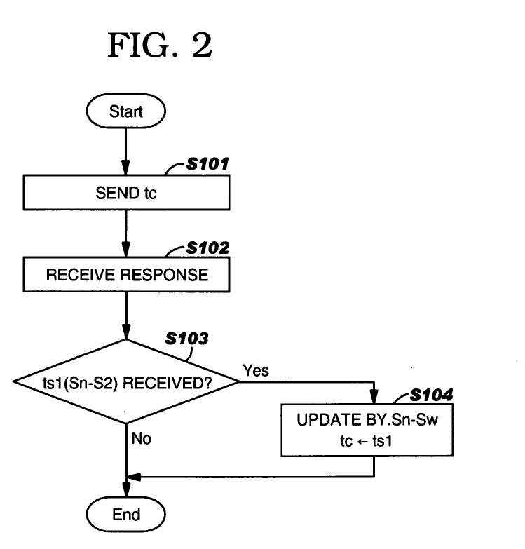

The operation of the client 10 will first be described with reference to FIG. 2.

In the client 10, the update request sending section 11 takes out the token tc from the token storage section 12 and transmits the token tc to the server 20 to make a request for update of the data set Sc stored in the data set storage section 13 (step 101).

Responsive to this request, processing described below is performed in the server 20. In the client, the update processing section 14 receives a response from the server 20 (step 102) and determines whether or not the response is the token ts1 and the difference (Sn-S2) (step 103). If the response is not the token ts1 and the difference (Sn-S2), the process ends. If the response is the token ts1 and the difference (Sn-S2), the update processing section 14 updates the data set Sc stored in the data set storage section 13 by using the difference (Sn-S2), and sets the value of the token ts1 as the token tc stored in the token storage section 12 (step 104), thereby completing the processing.

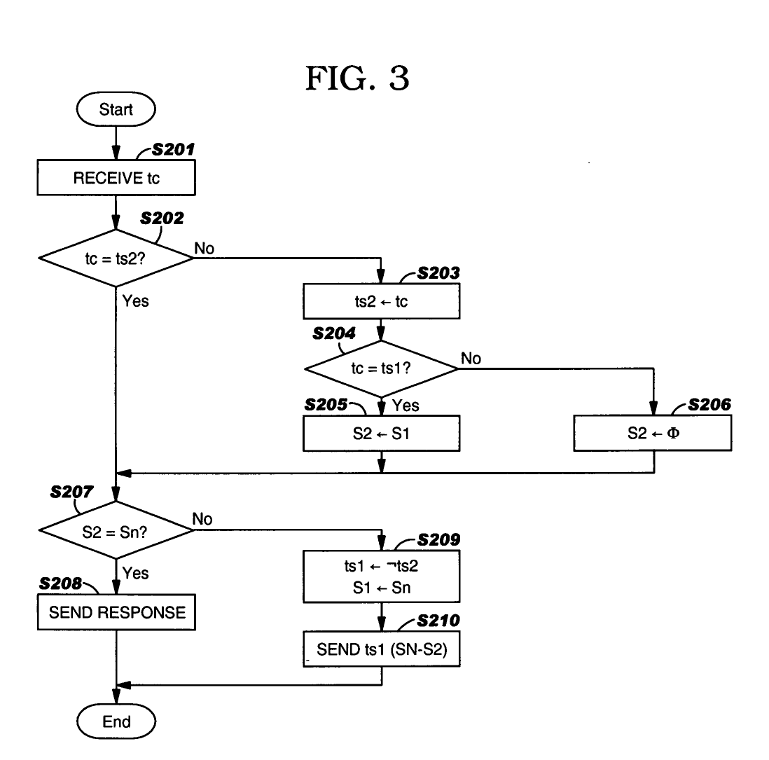

The operation of the server 20 will next be described with reference to FIG. 3.

In the server 20, the update request receiving section 21 receives the token tc (step 201) and hands over control to the sending-confirmed information updating section 22.

The sending-confirmed information updating section 22 determines whether or not the value of the received token tc is equal to the value of the token ts2 stored in the sending-confirmed information storage section 26 (step 202). If the result of this determination is that the value of the token tc is equal to the value of the token ts2, no further processing is performed, and the process moves to step 207. If the value of the token tc is not equal to the value of the token ts2, the sending-confirmed information updating section 22 sets the value of the token tc as the value of the token ts2 stored in the sending-confirmed information storage section 26 (step 203), and determines whether or not the value of the token tc is equal to the value of the token ts1 stored in the sent information storage section 25 (step 204).

If the result of this determination is that the value of the token tc is equal to the value of the token ts1, the sending-confirmed information updating section 22 replaces the sending-confirmed list stored in the sending-confirmed information storage section 26 with the sent list stored in the sent information storage section 25 (step 205). That is, the data set S2 identified from the sending-confirmed list that has been stored in the sending-confirmation information storage section 26 is replaced with the data set S1 identified from the sent list stored in the sent information storage section 25. If the value of the token tc is not equal to the value of the token ts1, the sending-confirmed information updating section 22 initializes the sending-confirmed list stored in the sending-confirmed information storage section 26 (step 206). That is, the data set S2 identified from the sending-confirmed list is replaced with null data.

The sent information updating section 23 determines whether or not the data set S2 identified from the sending-confirmed list stored in the sending-confirmed information storage section 26 is equal to the updated data set Sn stored in the updated data set storage section 27 (step 207).

If the result of this determination is that the data set S2 is equal to the data set Sn, the sent information updating section 23 sends a response indicating that the data set S2 is equal to the data set Sn (step 208). If the data set S2 is not equal to the data set Sn, the sent information updating section 23 sets as the token ts1 stored in the sent information storage section 25 a value different from the value of the token ts2 stored in the sending-confirmed information storage section 26, and replaces the data set S1 identified from the sent list stored in the sent information storage section 25 with the data set Sn (step 209).

The sent information updating section 23 sends the token ts1 stored in the sent information storage section 25 and the difference between the data set Sn and the data set S2 (Sn-S2) to the client 10 (step 210).

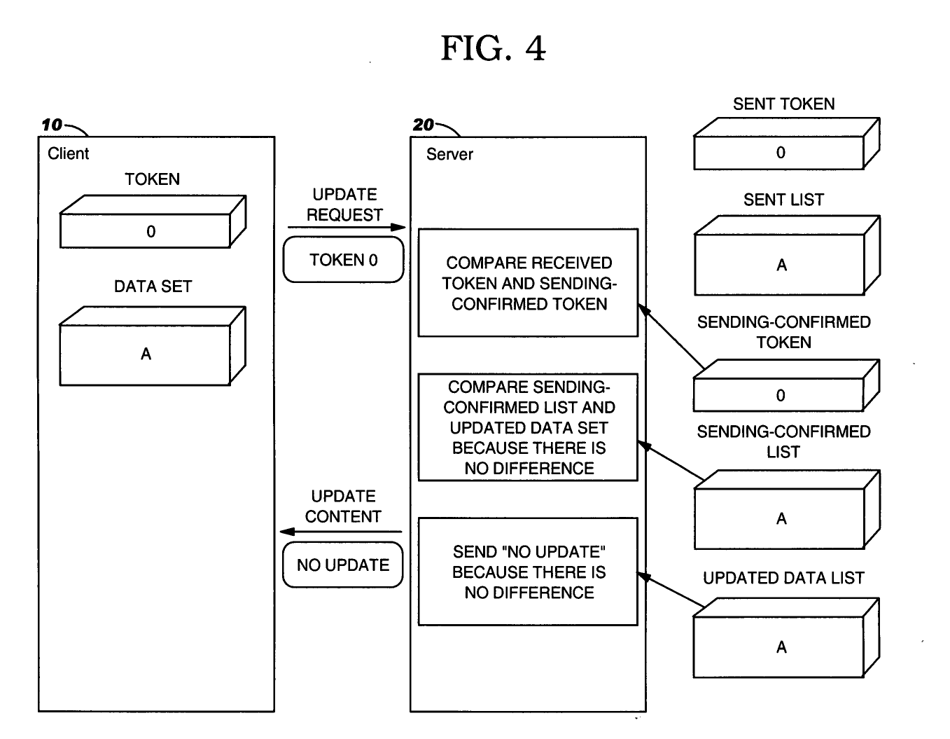

The operation of this illustrative embodiment will be now described with reference to specific examples. First, the operation in a state where no update is performed (steady state) will be described with reference to FIG. 4.

In this example, as shown in FIG. 4, the client 10 holds “0” as a token and also holds “A” as a data set, and the server 20 holds “0” as a sent token and also holds “0” as a sending-confirmed token. It is assumed that a data set identified from the sent list held by the server 20 is “A”, a data set identified from the sending-confirmed list held by the server 20 is “A”, and “A” is stored as an updated data set.

When the client 10 sends the token “0” in step 101, the server 20 receives the token in step 201 and compares the value of the received token and the value of the sending-confirmed token in step 202. In this case, both the tokens are “0”, and hence equal to each other. The process proceeds to step 207, and the data set identified from the sending-conformed list and the updated data set are compared with each other. In this case, both the data sets are “A”. The process therefore proceeds to step 208, and “no update” is set as a response to the client 10. In this case, update of the token and the data set is not performed in the client 10.

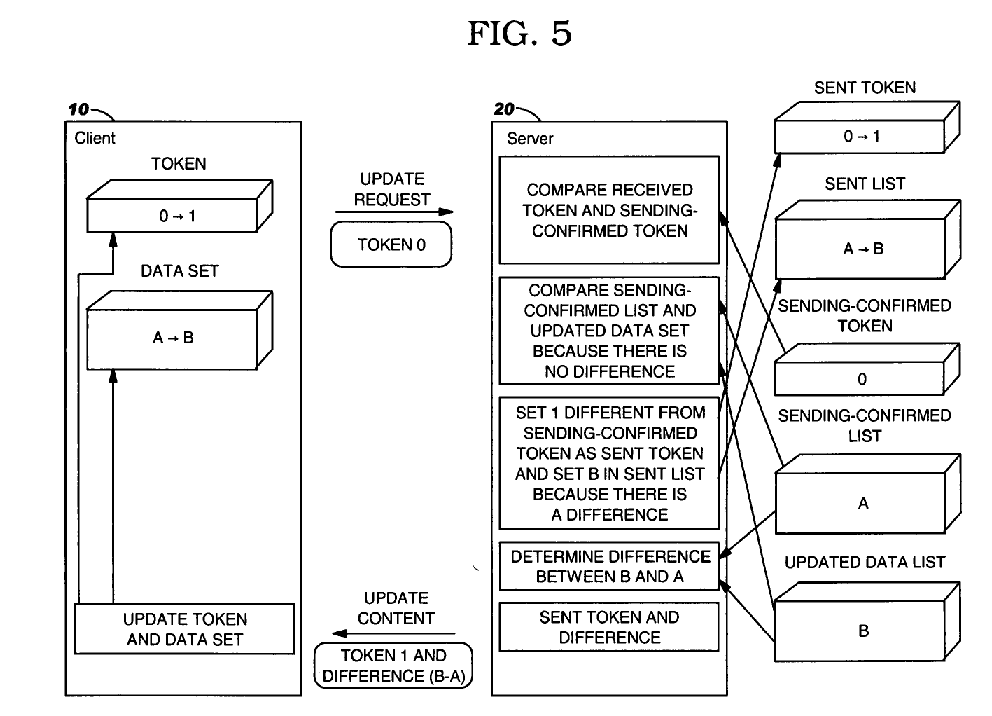

The operation of updating the data set will now be described with reference to FIG. 5. In this case, the initial state corresponds to the state at the time of completion of the operation shown in FIG. 4. That is, as shown in FIG. 5, the client 10 holds “0” as a token and also holds “A” as a data set, and the server 20 holds “0” as a sent token and also holds “0” as a sending-confirmed token. Here, a data set identified from the sent list held by the server 20 is “A”, a data set identified from the sending-confirmed list held by the server 20 is “A”, and “B” is stored as an updated data set.

When the client 10 sends the token “0” in step 101, the server 20 receives the token in step 201 and compares the value of the received token and the value of the sending-confirmed token in step 202. In this case, both the tokens are “0”, and hence equal to each other. The process proceeds to step 207, and the data set identified from the sending-conformed list and the updated data set are compared with each other. In this case, while the former data set is “A”, the latter data set is “B”. The process therefore proceeds to step 209, and “1” different from the sending-confirmed token “0” is set as the sent token. The data set identified from the sent list is changed from “A” to the updated data set “B”. In step 210, the sent token “1” and “B-A”, i.e., the difference between the data set identified from the sending-confirmed list and the updated data set, are sent.

The client 10 receives the response in step 102 and determines in step 103 whether the response is the sent token and the difference. In this case, the response is the sent token and the difference. The process therefore proceeds to step 104, the data set is updated to “B” by the received difference, and the received token “1” is set as the token in the client.

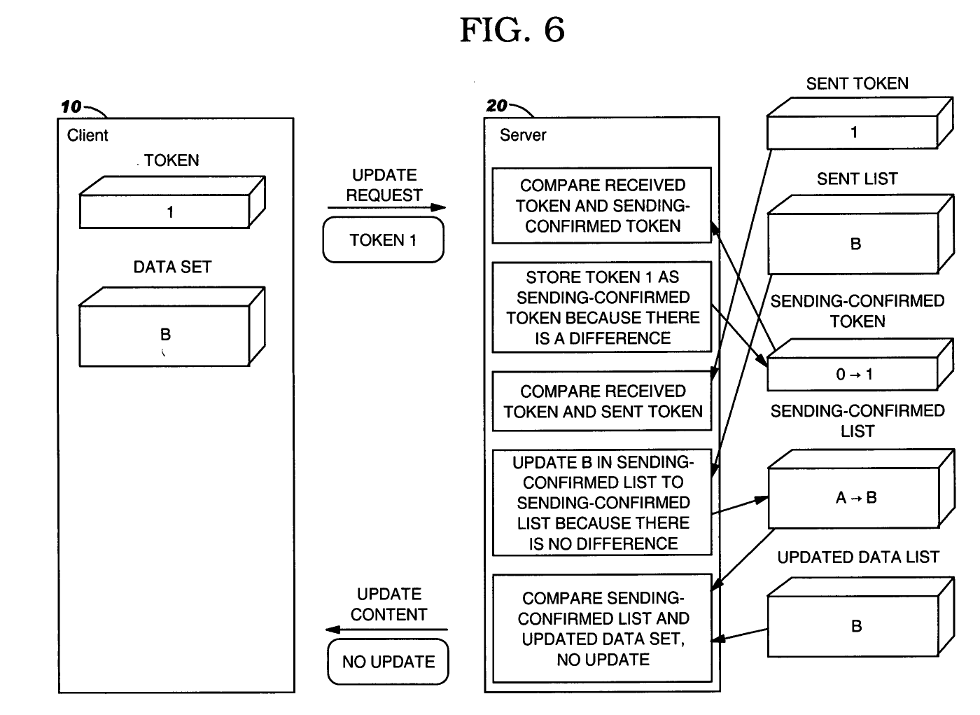

At this time, in the exemplary embodiment, the server 20 only sends the difference to the client 10, and has nothing to do with whether or not sending of the difference to the client 10 and update in the client 10 on the basis of the difference have been normally performed. These results are sent as the next update request from the client 10 to the server 20. The server 20 updates the sending-confirmed list for example, and returns to the steady state. This operation will be described with reference to FIG. 6.

In this example, it is assumed that initial state corresponds to the state at the time of completion of the operation shown in FIG. 5. That is, as shown in FIG. 6, the client 10 holds “1” as a token and also holds “B” as a data set, and the server 20 holds “1” as a sent token and also holds “0” as a sending-confirmed token. It is also assumed that a data set identified from the sent list held by the server 20 is “B”, a data set identified from the sending-confirmed list held by the server 20 is “A”, and “B” is stored as an updated data set.

When the client 10 sends the token “1” in step 101, the server 20 receives the token in step 201 and compares the value of the received token and the value of the sending-confirmed token in step 202. In this case, while the value of the received token is “1”, the value of the sending-confirmed token is “0”. The process therefore proceeds to step 203, and the received token “1” is set as the sending-confirmed token. In step 204, the value of the received token and the sent token are compared with each other. In this case, both the tokens are “1”. The process therefore proceeds to step 205 and the data set identified from the sending-confirmed list is changed from “A” to “B”. Thereafter, in step 207, the data set identified from the sending-confirmed list and the updated data set are compared. In this case, both the data sets are “B” and equal to each other. The process therefore proceeds to step 208 and “no update” is set as a response to the client 10. In this case, update of the token and the data set is not performed in the client 10.

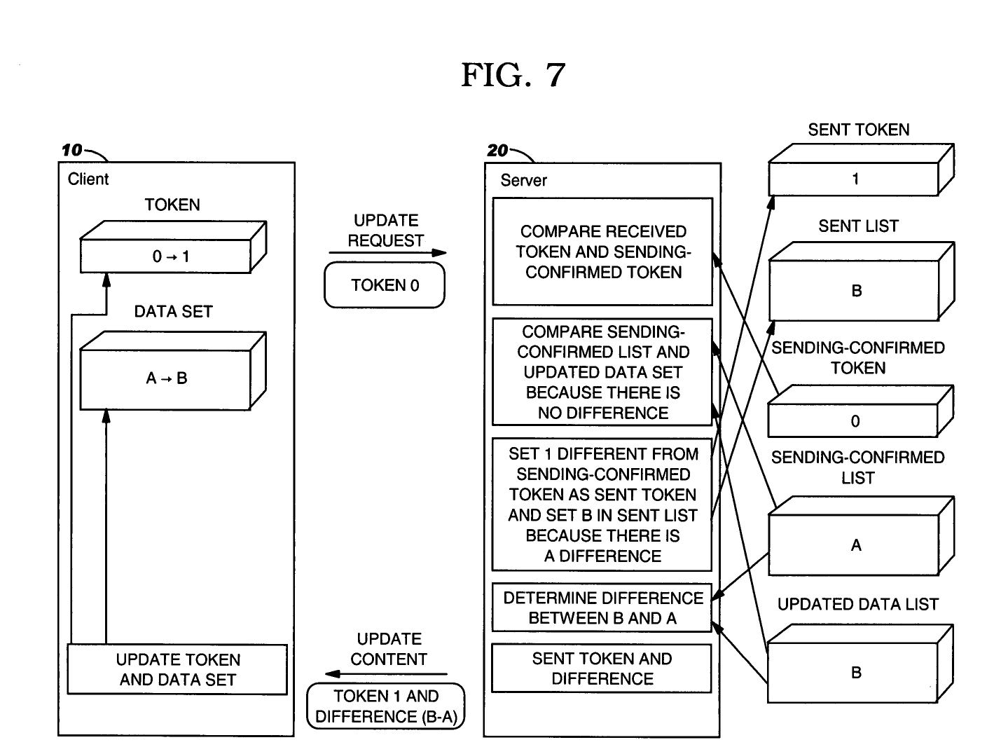

There is a possibility that the transmitted token and difference may not be sent to the client due to some error. In such a case, in this embodiment, the client 10 makes the same update request as that ordinarily made to request the server 20 to resend the lost update information. This operation will be described with reference to FIG. 7.

In this example, it is assumed that the initial state corresponds to a situation where an update is not performed in the client 10 as in the case shown in FIG. 5. That is, as shown in FIG. 7, the client 10 holds “0” as a token and also holds “A” as a data set, and the server 20 holds “1” as a sent token and also holds “0” as a sending-confirmed token. It is also assumed that a data set identified from the sent list held by the server 20 is “B”, a data set identified from the sending-confirmed list held by the server 20 is “A”, and “B” is stored as an updated data set.

When the client 10 sends the token “0” in step 101, the server 20 receives the token in step 201 and compares the value of the received token and the value of the sending-confirmed token in step 202. In this case, both the tokens are “0”, and hence equal to each other. The process therefore proceeds to step 207 and the data set identified from the sending-conformed list and the updated data set are compared with each other. In this case, while the former data set is “A”, the latter data set is “B”. The process therefore proceeds to step 209, “1” different from the sending-confirmed token “0” is set as the sent token and the data set identified from the sent list is changed from “A” to the updated data set “B”. In step 210, the sent token “1” and “B-A”, i.e., the difference between the data set identified from the sending-confirmed list and the updated data set, are sent.

The client 10 receives the response in step 102 and determines in step 103 whether the response is the sent token and the difference. In this case, the response is the sent token and the difference. The process therefore proceeds to step 104, the data set is updated to “B” by the received difference, and the received token “1” is set as the token in the client.

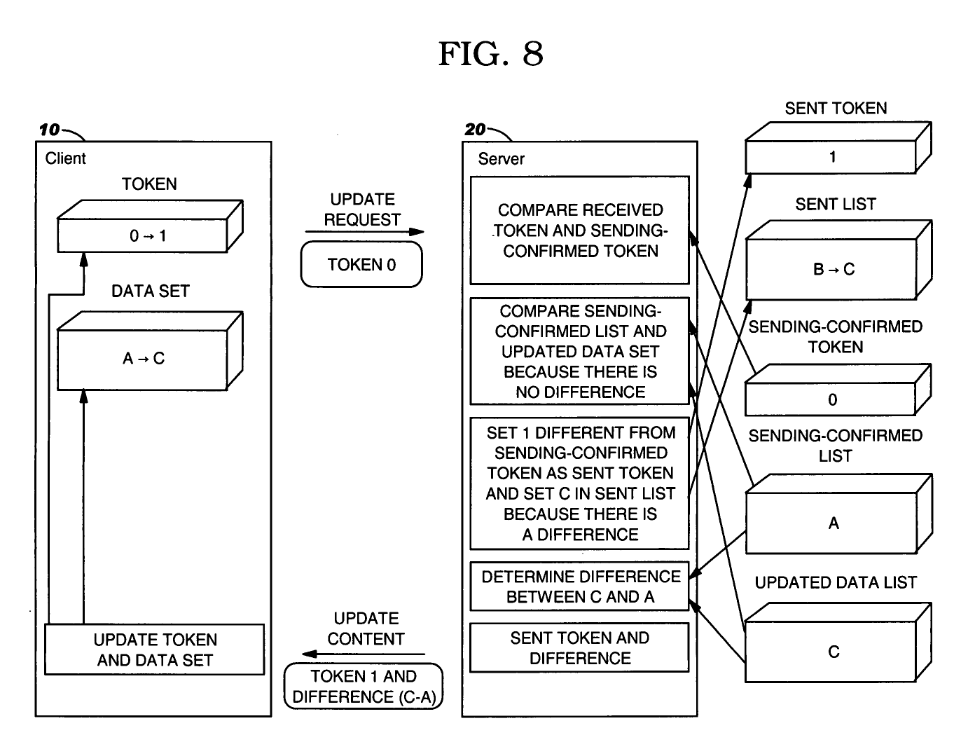

The operation will be described with reference to FIG. 8 for the case where the token and difference transmitted as shown in FIG. 5 is not sent to the client 10 due to some error and where the updated data set is thereafter changed.

First, as shown in FIG. 8, the client 10 holds “0” as a token and also holds “A” as a data set, and the server 20 holds “1” as a sent token and also holds “0” as a sending-confirmed token. It is assumed that a data set identified from the sent list held by the server 20 is “B”, a data set identified from the sending-confirmed list held by the server 20 is “A”, and “C” is stored as an updated data set.

When the client 10 sends the token “0” in step 101, the server 20 receives the token in step 201 and compares the value of the received token and the value of the sending-confirmed token in step 202. In this case, both the tokens are “0” and equal to each other. The process therefore proceeds to step 207 and the data set identified from the sending-conformed list and the updated data set are compared with each other. In this case, while the former data set is “A”, the latter data set is “C”. The process therefore proceeds to step 209, “1” different from the sending-confirmed token “0” is set as the sent token, and the data set identified from the sent list is changed from “B” to the updated data set “C”. In step 210, the sent token “1” and “C-A”, i.e., the difference between the data set identified from the sending-confirmed list and the updated data set, are sent.

The client 10 receives the response in step 102 and determines in step 103 whether the response is the sent token and the difference. In this case, the response is the sent token and the difference. The process therefore proceeds to step 104, the data set is updated to “C” by the received difference, and the received token “1” is set as the token in the client.

The examples described above are only some of the possible cases of the operation of this embodiment. Further description will therefore be made of the operation of the server 20 with respect to combinations of the token sent from the client 10, the sent token (list), the sending-confirmed token (list) and the updated data set. In the following, the set of each token and corresponding list is expressed in a form “token (list)”

In the case of received token “0”, sent token (list) “0(A)”, sending-confirmed token (list) “0(A)”, and updated data set “A”, the server 20 only returns “no update” and performs no other operation, as described above with reference to FIG. 4. In the case of received token “0”, sent token (list) “0(A)”, sending-confirmed token (list) “0(A)”, and updated data set “B”, the server 20 sends the token “1” and the difference “B-A” to the client 10 and updates the sent token (list) to “1(B)”, as described above with reference to FIG. 5. In the case of received token “0”, sent token (list) “1(B)”, sending-confirmed token (list) “0(A)”, and updated data set “B”, the server 20 sends the token “1” and the difference “B-A” to the client 10 and updates the sent token (list) to “(B)”, as described above with reference to FIG. 7. In the case of received token “0”, sent token (list) “1(B)”, sending-confirmed token (list) “0(A)”, and updated data set “C”, the server 20 sends the token “1” and the difference “C-A” to the client 10 and updates the sent token (list) to “1(C)”, as described above with reference to FIG. 8.

In the case of received token “1”, sent token (list) “0(A)”, sending-confirmed token (list) “0(A)”, and updated data set “A”, which case is not described with reference to any of FIGS. 4 to 8, some abnormality occurs in the course of processing. Referring to FIG. 3, the result of determination in step 202 is “NO”, the process therefore proceeds to step 203 and “1” is set as the sending-confirmed token. The result of determination in step 204 is “NO”. The process therefore proceeds to step 206 and a null data set is set as the data set identified from the sending-confirmed list. Accordingly, the result of determination in step 207 is “NO” and the token “0” different from the sending-confirmed token “1” and the difference between the updated data set and the null data set, i.e., the updated data set “A” itself, are sent to the client 10. In step 209, the sent token (list) is updated to “0(A)”.

In the case of received token “1”, sent token (list) “0(A)”, sending-confirmed token (list) “0(A)”, and updated data set “B”, which case is not described with reference to any of FIGS. 4 to 8, some abnormality occurs in the course of processing. Referring to FIG. 3, the result of the determination in step 202 is “NO”, the process therefore proceeds to step 203 and “1” is set as the sending-confirmed token. The result of the determination in step 204 is “NO”. The process therefore proceeds to step 206 and a null data set is set as the data set identified from the sending-confirmed list. Accordingly, the result of determination in step 207 is “NO” and the token “0” different from the sending-confirmed token “1” and the difference between the updated data set and the null data set, i.e., the updated data set “B” itself, are sent to the client 10. In step 209, the sent token (list) is updated to “0(B)”.

In the case of received token “1”, sent token (list) “1(B)”, sending-confirmed token (list) “0(A)”, and updated data set “B”, the server 20 updates the sending-confirmed token (list) to “11(B)”, as described above with reference to FIG. 6. In the case of received token “1”, sent token (list) “1(B)”, sending-confirmed token (list) “0(A)”, and updated data set “C”, which is a case where the updated data set is updated to “C” before entering the steady state in the case shown in FIG. 6, the server 20 updates the sending-confirmed token (list) to “1(B)”. Also, the server 20 sends the token “0” and the difference “C-B” and updates the sent token (list) to “0(C)”.

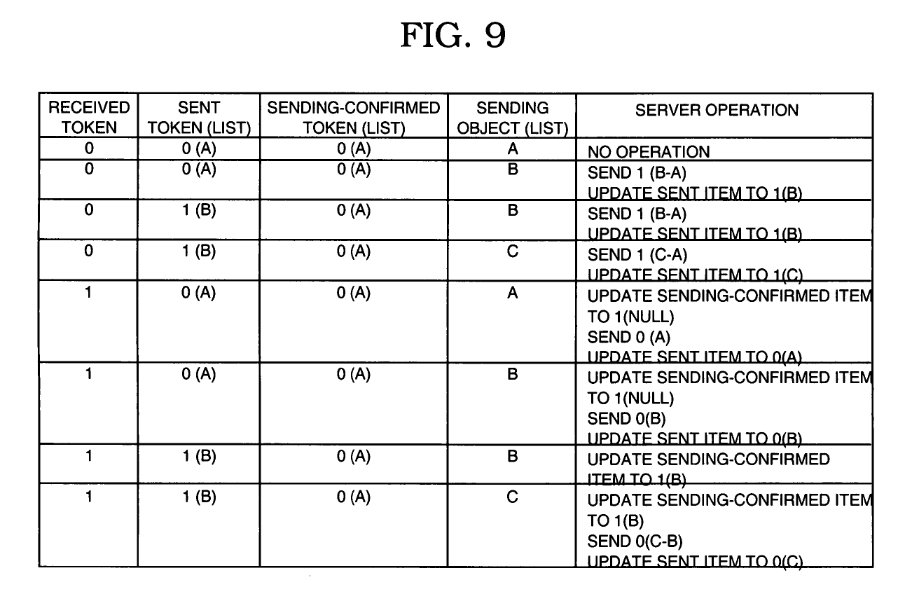

The relationship between the combination of tokens (lists) in FIG. 9 and the operation of the server 20 is also established even when the token values “0” and “1” are replaced with each other.

Tokens having three or more values may be used as well as the tokens having two values “0” and “1”. Such tokens can be used if processing for setting as ts1 a value different from ts2 in step 209 shown in FIG. 3 is replaced with processing for setting (ts2+1) as ts1 or the like, and if processing is performed in a round-robin manner by determining the maximum value that the token can assume.

In the case where the tokens are two-valued, the sent token (list) or the sending-confirmed token (list) changes as shown by “0(A)” →“1(B)”→“1(C)”. In this case, if the token (list) held by the client 10 is returned to “0(A)” for some reason, the operation is not normally performed thereafter.

In the case where the tokens are three-valued, the sent token (list) or the sending-confirmed token (list) changes as shown by “0(A)”→“1(B)”→“2(C)”. In this case, even if the token (list) held by the client 10 is returned to “0(A)” for some reason, recovery from this state to the normal operation can be made.

While information (a list of components) for identifying the contents of a data set is stored in the sent information storage section 25 and the sending-confirmed information storage section 26 in this embodiment, the corresponding data set itself may be stored.

Also, update information (e.g., update data and update instructions) sent from the update information sending section 24 to the client 10 may be stored directly in the sent information storage section 25. In such a case, processing for setting the data set identified by the sending-confirmed information storage section 26 as the data set updated on the basis of the update information stored in the sent information storage section 25 is performed in step 205.

In this exemplary embodiment, as described above, update information based on an updated data set is sent to a client, the updated data set is managed by using a sent list, and the updated data set is managed by using a sending-confirmed list if the state of the client holding the updated data set is confirmed when the next update request is made. This arrangement ensures that update of the data set held by the client can be performed with one transaction.

Also, confirmation as to whether or not the client is holding the updated data set is performed by using tokens that have two values, “0” and “1”. This arrangement ensures that the amount of data necessary for synchronous management accompanying update of the data set can be reduced.

While the embodiment has been described with respect to an example of an application to a client-server system, the present invention can also be applied to other suitable devices capable of communicating with each other.

We claim:

1. Data set updating apparatus comprising:
an update information sending section which sends update information to a client for updating a data set held by the client;
a sent information management section which manages the update information sent by the update information sending section;
an update request receiving section which receives an update request from the client, the update request including update condition information indicating the condition of update of the data set held by the client; and
a sending-confirmed information management section which manages, as sending-confirmed information indicating the update of data set according to the update information, update information stored as sent information in the client if it is determined that the client is holding the data set updated according to the update information on the basis of the update condition information received by the update request receiving section.

2. The data set updating apparatus according to claim 1, wherein the update request receiving section receives, as the update condition information, a value of a token changed when the data set held by the client is updated, and
wherein the sending-confirmed information management section determines whether or not the client is holding the data set updated according to the update information by comparing the value of the token received by the update request receiving section with the value of a sending-confirmed token changed when the sending-confirmed information is updated.

3. The data set updating apparatus according to claim 1, wherein the update request receiving section receives, as the update condition information, a value of a token which is changed when the data set held by the client is updated, and
wherein the sending-confirmed information management section determines whether the client is holding the data set updated according to the update information by comparing the value of the token received by the update request receiving section with the value of a sending-confirmed token which is changed when the sending-confirmed information is updated, and the value of a sent token which is changed when the sent information is updated.

4. Data set updating apparatus comprising:
a management information storage section which stores, for a data set sent to a client, sending-confirmed data set management information identifying content confirmed most recently in the client and sent data set management information identifying content updated according to update information sent most recently;
an update request receiving section which receives an update request including update condition information indicating the condition of update of the data set held by the client; and
a management information updating section which performs update processing for replacing the sending-confirmed data set management information in the management information storage section with the sent data set management information if it is determined that the content of the data set held by the client is different from the content of the data set identified from the sending-confirmed data set management information based on the update condition information received by the update request receiving section.

5. The data set updating apparatus according to claim 4, wherein the management information storage section stores a sending-confirmed token which indicates by at least one bit the condition of update of the sending-confirmed data set management information;
the update request receiving section receives as the update condition information a token which indicates by at least one bit the condition of update of the data set held by the client; and
the management information updating section determines that the content of the data set held by the client is different from the content of the data set identified from the sending-confirmed data set management information if the value of the received token is different from the value of the sending-confirmed token.

6. The data set updating apparatus according to claim 4, wherein the management information updating section performs the update processing if it is determined that the content of the data set held by the client is the same as the content of the data set identified from the sent data set management information based on the update condition information received by the update request receiving section.

7. The data set updating apparatus according to claim 6, wherein the management information storage section stores a sent token which indicates by at least one bit the condition of update of the sent data set management information;
the update request receiving section receives as the update condition information a token which indicates by at least one bit the condition of update of the data set held by the client; and
the management information updating section determines that the content of the data set held by the client is the same as the content of the data set identified from the sent data set management information if the value of the received token is the same as the value of the sent token.

8. The data set updating apparatus according to claim 4, wherein the management information updating section performs the update processing if it is determined that the content of the data set held by the client is the same as the content of the data set identified from the sent data set management information based on the update condition information received by the update request receiving section, and performs update processing for initializing the sending-confirmed data set management information in the management information storage section, if it is determined that the content of the data set held by the client is different from the content of the data set identified from the sent data set management information.

9. The data set updating apparatus according to claim 8, wherein the management information storage section stores a sent token which indicates by at least one bit the condition of update of the sent data set management information;
the update request receiving section receives as the update condition information a token which indicates by at least one bit the condition of update of the data set held by the client; and
the management information updating section determines whether or not the content of the data set held by the client is the same as the content of the data set identified from the sent data set management information by comparing the value of the received token and the value of the sent token.

10. A terminal device comprising:
a data set storage section which stores a data set;
an updated processing section which receives update information and updates the data set stored in the data set storage section according to the update information; and
an update request sending section which sends information indicating that update of the data set has been completed, the information being included in a request for further updating the updated data set.

11. A data set updating method comprising:
storing, for a data set sent to a client, sending-confirmed data set management information identifying content confirmed most recently in a client and sent data set management information identifying content updated according to update information sent most recently;
receiving an update request including update condition information indicating the condition of update of the data set held by the client; and
performing update processing for replacing the sending-confirmed data set management information with the sent data set management information if it is determined that the content of the data set held by the client is different from the content of the data set identified from the sending-confirmed data set management information based on the received update condition information.

12. The data set updating method according to claim 11, wherein the update processing is performed if it is determined that the content of the data set held by the client is the same as the content of the data set identified from the sent data set management information based on the received update condition information.

13. The data set updating method according to claim 11, wherein the update processing is performed if it is determined that the content of the data set held by the client is the same as the content of the data set identified from the sent data set management information on the basis of the received update condition information, and update processing for initializing the sending-confirmed data set management information is performed if it is determined that the content of the data set held by the client is different from the content of the data set identified from the sent data set management information.

14. A computer program product for operating, on a data set sent to a terminal, a server storing sending-confirmed data set management information identifying content confirmed most recently in the terminal, and sent data set management information identifying content updated according to update information sent most recently, the program enabling the server to perform functions of:
receiving an update request including update condition information indicating the condition of update of the data set held by the terminal; and
performing update processing for replacing the sending-confirmed data set management information with the sent data set management information if it is determined that content of the data set held by the terminal is different from content of the data set identified from the sending-confirmed data set management information on the basis of the received update condition information.

15. The computer program product according to claim 14, wherein the function of receiving the update request includes receiving a token which indicates by at least one bit the condition of update of the data set held by the terminal as the update condition information; and
wherein the function of performing the update processing includes determining that the content of the data set held by the terminal is different from the content of the data set identified from the sending-confirmed data set management information, if the value of the received token is different from the value of a sending-confirmed token which indicates by at least one bit the condition of update of the sending-confirmed data set management information.

16. The computer program product according to claim 14, wherein the function of performing the update processing includes performing the update processing if it is determined that the content of the data set held by the terminal is the same as the content of the data set identified from the sent data set management information based on the received update condition information.

17. The computer program product according to claim 16, wherein the function of receiving the update request includes receiving as the update condition information a token which indicates by at least one bit the condition of update of the data set held by the terminal; and
wherein the function of performing the update processing includes determining that the content of the data set held by the terminal is the same as the content of the data set identified from the sent data set management information if the value of the received token is the same as the value of a sent token which indicates by at least one bit the condition of update of the sent data set management information.

18. The computer program product according to claim 14, wherein the function of performing the update processing includes performing the update processing if it is determined that the content of the data set held by the terminal is the same as the content of the data set identified from the sent data set management information based on the received update condition information, and includes performing update processing for initializing the sending-confirmed data set management information if it is determined that the content of the data set held by the terminal is different from the content of the data set identified from the sent data set management information.

19. The computer program product according to claim 18, wherein the function of receiving the update request includes receiving a token which indicates by at least one bit the condition of update of the data set held by the terminal as the update condition information; and
wherein the function of performing the update processing includes determining whether content of the data set held by the terminal is the same as content of the data set identified from the sent data set management information by comparing the value of the received token and the value of a sent token which indicates by at least one bit the condition of update of the sent data set management information.

20. A computer program product for enabling a computer to perform functions of:
receiving update information and updating a data set according to the update information; and
transmitting information indicating the completion of update of the data set by including the information in a request for further updating the updated data set.
